(19) United States
(12) Patent Application Publication
(10) Pub. No.: US 2013/0282886 A1
(43) Pub. Date: Oct. 24, 2013

(54) NETWORK MANAGEMENT

(71) Applicants: Joseph E. Taylor, Fort Collins, CO (US); Wei Wen Chen, Fort Collins, CO (US); Peter C. Zwetkof, Greeley, CO (US)

(72) Inventors: Joseph E. Taylor, Fort Collins, CO (US); Wei Wen Chen, Fort Collins, CO (US); Peter C. Zwetkof, Greeley, CO (US)

(21) Appl. No.: 13/454,551

(22) Filed: Apr. 24, 2012

(51) Int. Cl. G06F 15/173

(52) U.S. Cl. 709/223

(57) ABSTRACT

The present disclosure provides methods, computer-readable media, and systems for managing a network with a network management device. Vendor specific discovery protocol data can be collected with the network management device from a network device in response to the network device having vendor specific discovery protocol data. Vendor neutral discovery protocol data can be collected with the network management device in response to the network device having vendor neutral discovery protocol data. A network connection can be assessed using the at least one of the vendor specific discovery protocol data and the vendor neutral discovery protocol data.

### BACKGROUND

Modern networks can include multiple network devices that are in communication with each other. The network devices can be provided by multiple vendors and can vary in number, complexity, and/or type of network device. The network devices can communicate information between each other through use of discovery protocols.

### BRIEF DESCRIPTION OF THE DRAWINGS

FIGS. 1A and 1B illustrate an example of a network topology according to the present disclosure.

FIG. 2 is a block diagram illustrating an example of a method for managing a network with a network management device according to the present disclosure.

FIG. 3 is a block diagram illustrating an example of a set of instructions for managing a network with a network management device according to the present disclosure.

FIG. 4 illustrates a block diagram of an example of a computer-readable medium in communication with memory resources and processor resources according to the present disclosure.

### DETAILED DESCRIPTION

The present disclosure provides methods, computer-readable media, and systems for managing a network with a network management device. Vendor specific discovery protocol data can be collected with the network management device from a network device in response to the network device having vendor specific discovery protocol data. Vendor neutral discovery protocol data can be collected with the network management device in response to the network device having vendor neutral discovery protocol data. A network connection can be assessed using the at least one of the vendor specific discovery protocol data and the vendor neutral discovery protocol data.

Some network devices in a network may be configured to communicate using discovery protocols that are specific to a vendor's devices, while some network devices may be configured to communicate using discovery protocols that are neutral among several vendors. As a result of the different communication protocols that can used, challenges can be created when attempting to monitor the network devices in the network.

Managing a network of devices can be made more efficient through use of a network management device. Use of a network management device can allow for discovery of network nodes, ports, and/or interfaces through various discovery protocols enabled on the network nodes, ports, and/or interfaces and can provide a representation of network topology. In an example, the network topology can be provided as a visual display of the various connections between network devices, which can be used for root cause analysis when a problem occurs with the network. For instance, a network device that is experiencing technical difficulties can be visually identified using the network topology. As such, an accurate representation of the network topology can be useful when performing root cause analysis.

However, incomplete and/or incorrect data can be collected from network devices with a network management device as a result of different discovery protocols being enabled on the network devices. For instance, vendor neutral discovery protocols can be enabled on some network devices, while vendor specific discovery protocols are enabled on other devices. Prior implementations of network management devices that collected information from only one discovery protocol could not collect data from network devices that had discovery protocols that were different than the discovery protocol used by the network management device, thus providing incomplete and/or incorrect data. In this instance, the network devices that data could not be collected from were not recognized by the network management device and therefore were not included on the network topology, which can have implications when performing root cause analysis using the network topology.

In addition, network management devices that collect information from only one discovery protocol can provide incomplete and/or incorrect data about a network device when the network device employs multiple discovery protocols. For example, a network device made by a vendor that has vendor specific discovery protocol enabled as well as a vendor neutral discovery protocol enabled may provide better data about the network device through the vendor specific protocol than the standard discovery protocol. As such, the network management device may collect incomplete and/or incorrect discovery protocol data if only the vendor neutral discovery protocol data is collected by the network management device.

Some examples of the present disclosure can collect vendor specific discovery protocol data and/or vendor neutral discovery protocol data from network devices. As such, devices that only have vendor specific discovery protocol data or vendor neutral discovery protocol data can be more accurately identified. In addition, examples of the present disclosure can determine what discovery protocol data to use when a network device has both vendor specific and vendor neutral discovery protocols enabled. As such, a complete and accurate network topology can be created, which can be beneficial when performing root cause analysis.

In the present disclosure, reference is made to the accompanying drawings that form a part hereof, and in which is shown by way of illustration how one or more examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

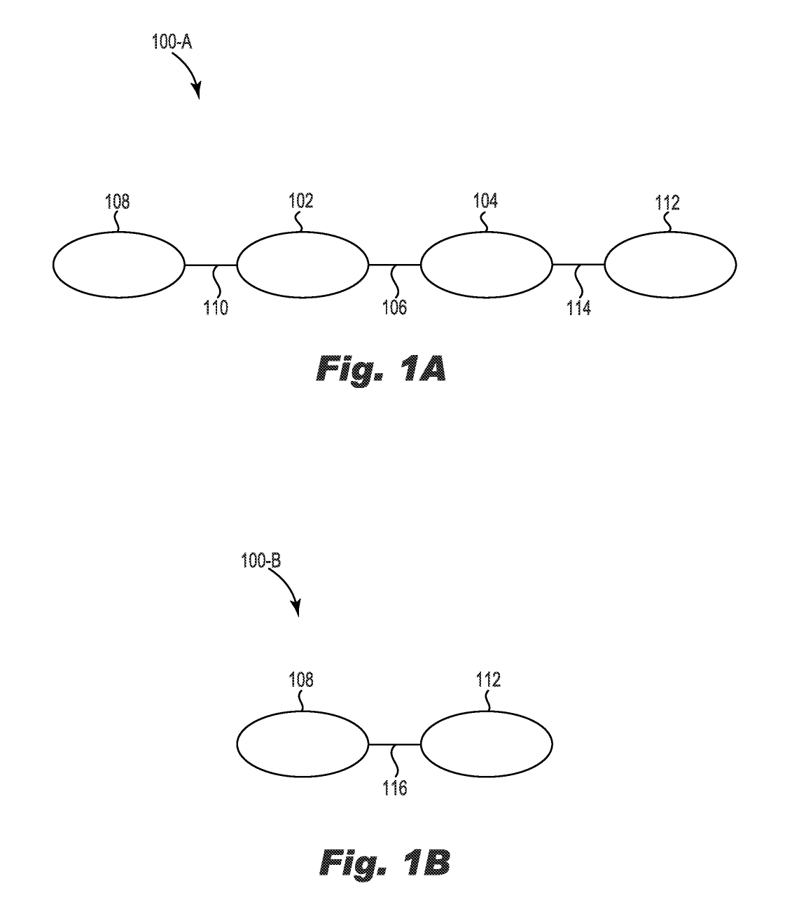

FIG. 1A illustrates an example of a network topology 100-A of a network according to the present disclosure. The network can include a first network device 102 and a second network device 104 that are in communication through a first network connection 106. The network can include a third network device 108 that is in communication with the first network device 102 through a second network connection 110. In addition, the network can include a fourth network device 112 that is in communication with the second network device 104 through a third network connection 114. In an example a vendor neutral discovery protocol can be enabled on corresponding interfaces between the first network device 102 and the second network device 104.

The vendor neutral discovery protocol data can be defined as data that identifies characteristics of a network device using a vendor neutral discovery protocol. For example, the vendor neutral discovery protocol can transmit data via a network connection regarding, for example, a device identification, capabilities (e.g., switch, router, bridge), port identification, and/or interface identification to devices that support the vendor neutral discovery protocol. Examples of the vendor neutral discovery protocol can include Link Layer Discovery Protocol (LLDP).

In an example, a vendor specific discovery protocol can be enabled on corresponding interfaces between the first network device 102 and the third network device 108 and can also be enabled on corresponding interfaces between the second network device 104 and the fourth network device 112. The vendor specific discovery protocol data can be defined as data that identifies characteristics of a network device using a vendor specific discovery protocol (e.g., a protocol owned by a single entity). For example, the vendor specific discovery protocol can transmit data via a network connection regarding, for example, a device identification, capabilities, port identification, and/or interface identification to the vendor's devices and other devices that support the vendor specific discovery protocol. Examples of the vendor specific discovery protocol can include Cisco® Discovery Protocol (CDP), Foundry Discovery Protocol (FDP), and/or Nortel's® SynOptcis Network Management Protocol (SONMP), among others.

As discussed herein, prior implementations of network management devices that collected information from only one discovery protocol could not collect data from network devices that had discovery protocols that were different than the discovery protocol used by the network management device. In an example where a network management device only collects vendor specific discovery protocol data, vendor neutral discovery protocol data will not be collected from the corresponding interfaces between the first network device 102 and the second network device 104. However, vendor specific discovery protocol data will be collected from the corresponding interfaces between the third network device 108 and the second network device 102 and from the corresponding interfaces between the fourth network device 112 and the second network device 104.

This can result in a network topology that does not account for the first network device 102, the second network device 104, or the network connection 106, resulting in a network topology shown in FIG. 1B. For example, the network topology 100-B can display a network, where the third network device 108 and the fourth network device 112 have corresponding interfaces connected by network connection 116. As such, an inaccurate network topology 100-B of the network can be provided by a network management device that only collects network device information from one discovery protocol (e.g., vendor specific discovery protocol). In contrast, examples of the present disclosure can result in a network topology that displays the first network device 102, second network device 104, third network device 108, and fourth network device 112 and their associated network connections (e.g., 106, 110, 114) as a result of the ability to collect vendor specific discovery protocol data and/or vendor neutral discovery protocol data.

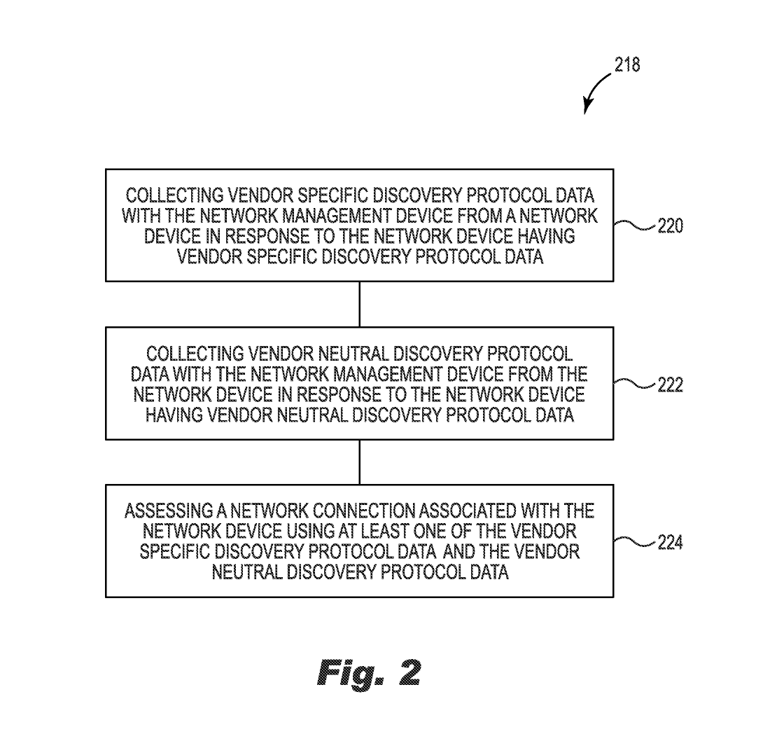

FIG. 2 is a flow chart illustrating an example of a method 218 for managing a network with a network management device according to the present disclosure. The method can include collecting 220 vendor specific discovery protocol data with the network management device from a network device in response to the network device having vendor specific discovery protocol data. In an example, the network device can include a router, switch, computer, and/or bridge, although examples are not so limited.

The method can include collecting 222 vendor neutral discovery protocol data with the network management device from the network device in response to the network device having vendor neutral discovery protocol data. Generally, the vendor neutral discovery protocol can be supported by more network devices than a vendor specific discovery protocol, because it is not owned by a single entity. However, the vendor neutral discovery protocol may not be specifically tailored to a vendor's particular network device like a vendor specific discovery protocol and therefore may provide an incomplete representation of data associated with the network device and/or may provide an incorrect representation of data associated with the network device. As such, when a network device supports both a vendor specific discovery protocol and a vendor neutral discovery protocol, challenges can be presented in determining what discovery protocol to use when collecting data from the network device. For example, collection of data that incompletely and/or inaccurately represents a network device can have consequences when the data is used for assessing a network connection associated with the network device, as discussed herein.

Accordingly, examples of the present disclosure can include comparing at least one of the vendor specific discovery protocol data and the vendor neutral discovery protocol data with a marker. In an example, the marker can include data associated with a previously discovered node, interface, and/or port. For instance, discovery protocol data associated with a data profile of a previously discovered node, interface, and/or port can be compared with the vendor specific discovery protocol data and/or the vendor neutral discovery protocol data. Upon comparison of the vendor specific protocol data and/or the vendor neutral discovery protocol data with the marker, a determination of whether a match exists between the marker and the vendor specific discovery protocol data and/or the vendor neutral discovery protocol data can be made.

In an example, the method can include selecting at least one of the vendor specific discovery protocol data and the vendor neutral discovery protocol data based upon the comparison of the at least one of the vendor specific discovery protocol data and the vendor neutral discovery protocol data with the marker. For instance, the vendor specific discovery protocol data and/or the vendor neutral discovery protocol data can be selected if a match exists between the marker and the vendor specific discovery protocol data and/or the vendor neutral discovery protocol data. Alternatively, the discovery protocol data that produces a better match with the marker can be selected. For example, if the vendor neutral discovery protocol data produces a better match with the marker than the vendor specific discovery protocol data, then the vendor neutral discovery protocol data can be selected.

The method can include collecting the vendor specific discovery protocol data from a vendor specific discovery protocol management information base and/or collecting the vendor neutral discovery protocol data from a vendor neutral discovery protocol management information base. Both management information bases can be included on the network device and can contain tables that are accessible via a query using simple network management protocol (SNMP). The tables can store data that is received from neighboring devices. In an example, the vendor specific discovery protocol management information base can include data that is received from neighboring devices via the vendor specific discovery protocol and the vendor neutral discovery protocol information base can include data that is received from neighboring devices via the vendor neutral discovery protocol. When vendor specific discovery protocol data and/or vendor neutral discovery protocol data is not received from a neighboring device for a period of time, the corresponding data in the vendor specific discovery protocol management information base and/or vendor neutral discovery protocol management information base can be deleted. Thus, the management information bases can contain records of neighboring network devices that are operational (e.g., sending data to the network device).

In an example, the vendor specific discovery protocol data and/or the vendor neutral discovery protocol data can be collected from the network device by the network management device through a SNMP query. As such, the network device is not required to use the vendor specific discovery protocol and/or the vendor neutral discovery protocol when collecting data from the network device, use of which can cause an increase in complexity and processing resources used by the network management device.

The method can include assessing 224 a network connection associated with the network device using at least one of the vendor specific discovery protocol data and the vendor neutral discovery protocol data. In an example, the data contained in the vendor neutral and/or vendor specific management information base can be used to assess the network connection. For instance, the network management device can collect the vendor specific discovery protocol data and/or the vendor neutral discovery protocol data and determine whether the network device is connected to other network devices by analyzing the vendor specific discovery protocol data and/or the vendor neutral discovery protocol data in the management information base tables.

In an example, a network topology can be created based on the assessment of the network connection associated with the network device. For instance, a visual display of various network connections associated with the network device can be created. Neighboring network devices can be displayed relative to the network device as well their associated network connections. As discussed herein, the network topology can be used for root cause analysis of the network. For example, a network device that is experiencing technical difficulties can be identified using the network topology.

Examples of the present disclosure can help to avoid instances where incomplete and/or incorrect data is collected from network devices with a network management device as a result of different discovery protocols being enabled on the network devices. For example, instances where an assessment performed by a network management device only collects vendor specific discovery protocol data from a network device that has both vendor specific discovery protocol data and vendor neutral discovery protocol data enabled can create a situation where the assessment does not detect the vendor neutral discovery protocol data and potentially misses an associated network connection. As such, if a network topology is created, the network connection associated with the vendor specific discovery protocol would be the only network connection displayed.

In contrast, examples of the present disclosure can assess a first network connection on the network device with a vendor specific discovery protocol enabled and can assess a second network connection on the network device with a vendor neutral discovery protocol enabled. As such, a network topology can be created based on the assessment of the first and second network connections associated with the network device and a visual display of both of the network connections associated with the network device can be created, aiding in root cause analysis.

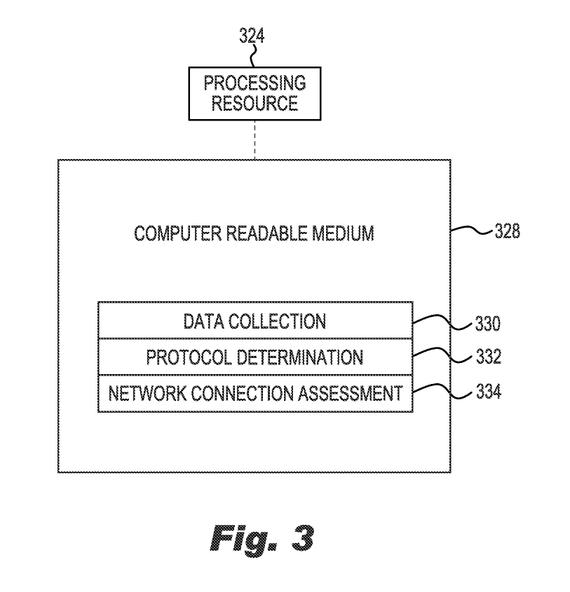

FIG. 3 is a block diagram illustrating a processing resource 446 and a computer-readable medium 328 according to the present disclosure. The computer-readable medium 328 (e.g., a tangible, non-transitory medium) can store a set of instructions executable by the processing resource 446 for managing a network with a network management device according to the present disclosure. The instructions 330 can be executed to collect discovery protocol data from a network device with the network management device through a simple network management protocol query. The discovery protocol data can include vendor specific discovery protocol data and/or vendor neutral discovery protocol data.

In an example, instructions can be executed to collect the discovery protocol data associated with a node, port, and/or interface of the network device. The discovery protocol data associated with the node, port, and/or interface can be compared with previously collected discovery protocol data associated with the node, port, and/or interface to determine whether a match exists. This can be beneficial in an example where the network management device collects data associated with multiple discovery protocols that are enabled on the same network device. In an example, based upon the comparison, the network management device can determine the best discovery protocol to use.

For instance, vendor specific discovery protocol data and vendor neutral discovery protocol data associated with the node, port, and/or interface can be compared with the previously collected discovery protocol data associated with the node, port, and/or interface to determine whether a match exists and/or to determine which discovery protocol data provides a better match. The discovery protocol data that matches and/or provides a better match can then be used to assess a network connection associated with the network device to ensure that an accurate assessment of the network connection can be made.

Examples of the present disclosure can include instructions to collect at least one of the vendor specific discovery protocol data and vendor neutral discovery protocol data from the network device based on a user configuration of the device. In an example, a vendor specific discovery protocol and a vendor neutral discovery protocol may be enabled on the device, however, the device may have been configured to use a particular discovery protocol over the other discovery protocol. As such, the network management device can collect data associated with the discovery protocol that the network device has been configured to use.

Examples of the present disclosure can include instructions to collect at least one of the vendor specific discovery protocol data and the vendor neutral discovery protocol data by default. For instance, instructions can be executed to collect only vendor specific discovery protocol data. Alternatively, instructions can be executed to collect only vendor neutral discovery protocol data. This can be beneficial when one discovery protocol is known to be problematic and/or is known to provide incomplete and/or incorrect data.

In addition, examples of the present disclosure can include instructions to collect data from a particular type of device using a particular discovery protocol. In an example, the particular discovery protocol may work better for the particular device and/or a user may prefer to use the particular discovery protocol for the particular device.

The instructions 332 can be executed to determine that the discovery protocol data is at least one of vendor specific discovery protocol data and vendor neutral discovery protocol data. The instructions 334 can be executed to assess a network connection associated with the network device using at least one of the vendor specific discovery protocol data and the vendor neutral discovery protocol data.

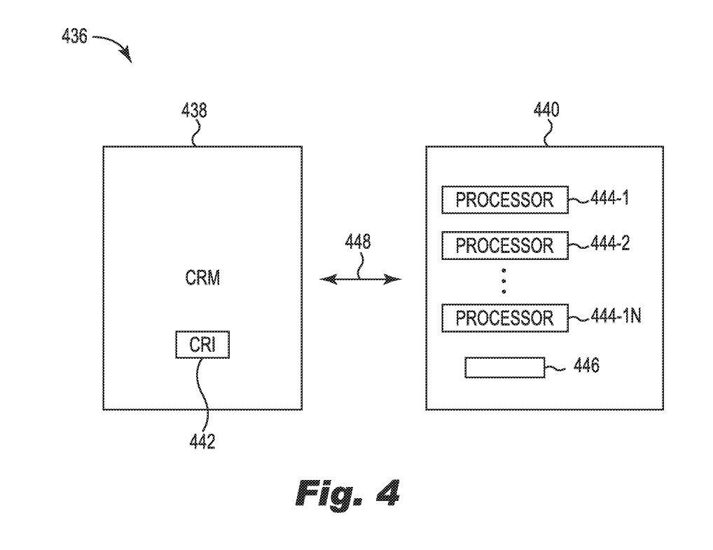

FIG. 4 illustrates a block diagram 436 of an example of a computer-readable medium in communication with memory resources and processing resources for managing a network with a network management device according to the present disclosure. Computer-readable medium (CRM) 438 can be in communication with a computing device 440 having processor resources of more or fewer than 444-1, 444-2, . . . , 444-N, that can be in communication with, and/or receive a tangible non-transitory CRM 438 storing a set of computer-readable instructions 442 executable by one or more of the processor resources (e.g., 444-1, 444-2, . . . , 444-N) for managing a network with a network management device. The computing device 440 may include memory resources 446, and the processor resources 444-1, 444-2, . . . , 444-N may be coupled to the memory resources 446.

Processor resources 444-1, 444-2, . . . , 444-N can execute computer-readable instructions 442 for managing a network with a network management device and are stored on an internal or external non-transitory CRM 438. Computer-readable instructions 442 can be executed to collect discovery protocol data from a group of network devices with the network management device. Further, computer-readable instructions can be executed to determine that mixed discovery protocols are enabled on the group of network devices through analysis of the discovery protocol data. In an example, a vendor neutral discovery protocol can be enabled on a network device, while a vendor specific discovery protocol can be enabled on a neighboring network device, for example.

Computer-readable instructions 442 can be executed to create a network topology model using the discovery protocol data associated with the mixed discovery protocols. As discussed herein, the network topology can be a visual display of various network connections associated with the group of network devices. In an example, names and data associated with the group of devices can be displayed on the network topology. In addition, data associated with the various network connections existing between the group of network devices can be displayed on the network topology. For instance, the type of discovery protocol used by the various network connections can be displayed.

In an example, a network topology can be created based on the assessment of the network connection associated with the network device as well as a visual display of various network connections associated with the network device. Neighboring network devices can be displayed relative to the network device as well their associated network connections. As discussed herein, the network topology can be used for root cause analysis of the network. For example, a network device that is experiencing technical difficulties can be identified using the network topology.

The group of network devices can include a first network device and a second network device that have a vendor neutral discovery protocol enabled on corresponding interfaces between the first network device and the second network device; a third network device that has a vendor specific discovery protocol enabled on corresponding interfaces between the first network device and the third network device; and a fourth network device that has a vendor specific discovery protocol enabled on corresponding interfaces between the second network device and the fourth network device. Prior solutions that employ network management devices that only collect data associated with a vendor specific discovery protocol, for example, will not show the first and second network devices that have the vendor neutral discovery protocol enabled on their corresponding interfaces or the associated network connection on a network topology.

For example, prior solutions employing network management devices that only collect data associated with vendor specific discovery protocols will not collect the vendor neutral discovery protocol data, resulting in a network topology that displays the third network device and the fourth network device as being connected through a network connection. Use of prior solutions that employ network management devices that only collect vendor neutral discovery protocol data will also result in a network topology that displays that the third network device and the fourth network device are connected when the first network device and a second network device have a vendor specific discovery protocol enabled on corresponding interfaces between the first network device and the second network device; the third network device that has a vendor neutral discovery protocol enabled on corresponding interfaces between the first network device and the third network device; and the fourth network device that has a vendor neutral discovery protocol enabled on corresponding interfaces between the second network device and the fourth network device. In contrast, examples of the present disclosure can result in a network topology that displays the first, second, third, and fourth network devices and their associated network connections as a result of the ability to collect vendor specific discovery protocol data and/or vendor neutral discovery protocol data.

A non-transitory CRM (e.g., 438), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), Blu-ray discs (BD), compact discs (CD), and/or a solid state drive (SSD), flash memory, etc., as well as other types of CRM.

The non-transitory CRM 438 can be integral, or communicatively coupled, to a computing device, in either a wired or wireless manner. For example, the non-transitory CRM can be an internal memory, a portable memory, a portable disk, or a memory located internal to another computing resource (e.g., enabling the computer-readable instructions 442 to be downloaded over the Internet).

The CRM 438 can be in communication with the processor resources (e.g., 444-1, 444-2, . . . , 444-N) via a communication path 448. The communication path 448 can be local or remote to a machine associated with the processor resources 444-1, 444-2, . . . , 444-N. Examples of a local communication path 448 can include an electronic bus internal to a machine such as a computer where the CRM 438 is one of volatile, non-volatile, fixed, and/or removable storage medium in communication with the processor resources (e.g., 444-1, 444-2, . . . , 444-N) via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 448 can be such that the CRM 438 is remote from the processor resources (e.g., 444-1, 444-2, . . . , 444-N) such as in the example of a network connection between the CRM 438 and the processor resources (e.g., 444-1, 444-2, . . . , 444-N). That is, the communication path 448 can be a network connection. Examples of such a network connection can include a local area network (LAN), a wide area network (WAN), a personal area network (PAN), and the Internet, among others. In such examples, the CRM 438 may be associated with a first computing device and the processor resources (e.g., 444-1, 444-2, . . . , 444-N) may be associated with a second computing device.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

The term “a number of” is meant to be understood as including at least one but not limited to one.

What is claimed:

1. A method for managing a network with a network management device, comprising:
collecting vendor specific discovery protocol data with the network management device from a network device in response to the network device having vendor specific discovery protocol data;
collecting vendor neutral discovery protocol data with the network management device from the network device in response to the network device having vendor neutral discovery protocol data; and
assessing a network connection associated with the network device using at least one of the vendor specific discovery protocol data and the vendor neutral discovery protocol data.

2. The method of claim 1, wherein collecting the vendor specific discovery protocol data includes collecting the vendor specific discovery protocol data from a vendor specific discovery protocol management information base.

3. The method of claim 1, wherein collecting the vendor neutral discovery protocol data includes collecting the vendor neutral discovery protocol data from a vendor neutral discovery protocol management information base.

4. The method of claim 1, wherein the vendor neutral discovery protocol includes a Link Layer Discovery Protocol (LLDP).

5. The method of claim 1, wherein the method includes collecting data through a simple network management protocol.

6. The method of claim 1, wherein the method includes comparing at least one of the vendor specific discovery protocol data and the vendor neutral discovery protocol data with a marker.

7. The method of claim 6, wherein the method includes selecting at least one of the vendor specific discovery protocol data and the vendor neutral discovery protocol data based upon the comparison of the at least one of the vendor specific discovery protocol data and the vendor neutral discovery protocol data with the marker.

8. The method of claim 1, wherein the method includes:
assessing a first network connection on the network device with a vendor specific discovery protocol enabled; and
assessing a second network connection on the network device with a vendor neutral discovery protocol enabled.

9. A non-transitory computer-readable medium storing instructions for managing a network with a network management device executable by a computer to cause the computer to:
collect discovery protocol data from a network device with the network management device through a simple network management protocol;
determine that the discovery protocol data is at least one of vendor specific discovery protocol data and vendor neutral discovery protocol data; and
assess a network connection associated with the network device using at least one of the vendor specific discovery protocol data and the vendor neutral discovery protocol data.

10. The computer-readable medium of claim 9, wherein the instructions include instructions to collect the discovery protocol data associated with at least one of a node, port, and interface of the network device.

11. The computer-readable medium of claim 10, wherein the instructions include instructions to collect at least one of the vendor specific discovery protocol data and vendor neutral discovery protocol data from the network device based on a user configuration of the device.

12. The computer-readable medium of claim 10, wherein the instructions include instructions to determine whether the discovery protocol data associated with at least one of the node, port, and interface of the network device matches previously collected discovery protocol data associated with at least one of the node, port, and interface.

13. The computer-readable medium of claim 10, wherein the instructions include instructions to collect at least one of the vendor specific discovery protocol data and the vendor neutral discovery protocol data by default.

14. A system for managing a network with a network management device, the system comprising a processing resource in communication with a non-transitory computer-readable medium, wherein the computer-readable medium contains a set of instructions and wherein the processing unit is designed to carry out the set of instructions to:
collect discovery protocol data from a group of network devices with the network management device;
determine that mixed discovery protocols are enabled on the group of network devices through analysis of the discovery protocol data;
create a network topology model using the discovery protocol data associated with the mixed discovery protocols.

15. The system of claim 14, wherein the group of network devices includes:
a first network device and a second network device, wherein a vendor neutral discovery protocol is enabled on corresponding interfaces between the first network device and the second network device;
a third network device, wherein a vendor specific discovery protocol is enabled on corresponding interfaces between the first network device and the third network device; and
a fourth network device, wherein a vendor specific discovery protocol is enabled on corresponding interfaces between the second network device and the fourth network device.
